(19) United States
(12) Patent Application Publication
(10) Pub. No.: US 2015/0332182 A1
(43) Pub. Date: Nov. 19, 2015

(54) METHOD FOR MEASURING RISKS AND OPPORTUNITIES DURING PATIENT CARE

(71) Applicant: Lightbeam Health Solutions, LLC, Irving, TX (US)

(72) Inventors: Patrick Cline, Irving, TX (US); Jibu George, Irving, TX (US); Robert Nary, Irving, TX (US); Michael Hoxter, Irving, TX (US); Jerry Shultz, Irving, TX (US)

(21) Appl. No.: 14/714,185

(22) Filed: May 15, 2015

Related U.S. Application Data
(60) Provisional application No. 61/993,444, filed on May 15, 2014.

(51) Int. Cl. G06Q 10/06; G06F 19/00

(52) U.S. Cl. CPC G06Q 10/0631; G06F 19/3431

(57) ABSTRACT

A method maximizes the usefulness of resources to be allocated to a class of patients. The method includes the steps of receiving data on a patient. The date is then partitioned. From the partitioned data, a patient factor score calculation is calculated. In addition, a patient illness correlation score is calculated. From the patient factor score and patient illness correlation score, an Ability to Impact score for each patient is generated to identify uses of resources by which the resources will be applied to the patient to maximize the effectiveness of the resources.

### BACKGROUND ART

1. Field of The Invention

The invention relates to a method for stratifying patient risk and prioritizing care opportunities based on the potential or probability of avoidable costs.

2. Description of the Related Art

Health systems, payers and provider organizations, especially those involved in risk or quality-based reimbursement, do not have a solution identifies patients based on their potential avoidable costs. This leads to a number of problems such as; lacking a way to measure the effectiveness and return on investment of their care management programs and care managers, directing their resources to the patients with the highest potential for a positive financial or quality impact, determining what patients to focus on, and how many resources are needed. They have no way of truly knowing if the patients assigned to each care manager are doing better because of their actions or because the patient manages their own condition. They cannot determine the impact of their care management programs effectiveness. Current systems base acuity and stratify largely on claims data, diagnosis and comorbidities. These systems do not include sophisticated predictive algorithms that score a patient by quantifying the potential for avoidable costs and improved outcomes based on detailed discrete information including but not limited to medical, social, family histories, economic information, credit scores or knowledge that the patient personally tracks their biometrics such as pulse, oxygen levels and blood sugar.

### SUMMARY OF THE INVENTION

A method maximizes the usefulness of resources to be allocated to a class of patients. The method includes the steps of receiving data on a patient. The date is then partitioned. From the partitioned data, a patient factor score calculation is calculated. In addition, a patient illness correlation score is calculated. From the patient factor score and patient illness correlation score, an Ability to Impact score for each patient is generated to identify uses of resources by which the resources will be applied to the patient to maximize the effectiveness of the resources.

### BRIEF DESCRIPTION OF THE DRAWINGS

Advantages of the invention will be readily appreciated, as the same becomes better understood by reference to the following detailed description when considered in connection with the accompanying drawings, wherein:

FIG. 1 is a schematic representation of a healthcare data ecosystem incorporating one embodiment of the invention;

FIG. 2 is a schematic flow chart of a method to identify an illness correlation score;

FIG. 3 is a schematic flow chart initiating the development of a patient factor score;

FIG. 4 is a schematic flow chart completing the patient factor score;

FIG. 5A is a schematic flow chart of how an ATI score for a patient is calculated;

FIG. 5B is a graphic representation of data used to calculate an ATI score; and

FIG. 6 is a schematic flow chart of the calculation of the ATI score database.

### DETAILED DESCRIPTION OF THE DRAWINGS

The invention identifies, scores and ranks patients and populations based on the potential for avoidable costs. More specifically, the invention identifies and highlights patients based on predictive factors that indicate when an intervention will lead to avoidable costs. By way of example, there is a low probability of reducing significant costs or improving outcome significantly by assigning a care manager and/or social worker to a patient with fourth stage cancer.

In another example, two patients with chronic obstructive pulmonary disease (COPD) are compared. By looking at combinations of factors like depression, cohabitation, medications, medication compliance, socialization, credit scores, and medical testing compliance, it can be determined which of the two patients are more likely to require a hospital visit or a trip to an emergency room. The invention also breaks a group of COPD patients into multiple risk categories. One category includes patients that manage their condition very well and therefore have a lower potential for cost avoidance. Assigning them to care management and having a care manager call them will not reduce the cost of care, or significantly improve the outcome. Another category of patients with a higher probability of cost avoidance, however, is the category to which the time and attention of a care manager should be directed. Aggressively managing this category of patients leads to improved outcomes and reduced costs. By utilizing the inventive method and system, the highest potential for cost avoidance can be identified by publishing this information to end users, care managers, care management systems, analytics platforms, stratification systems, and to be recorded in electronic health records (EHR) of providers of such services, e.g., hospitals and emergency rooms.

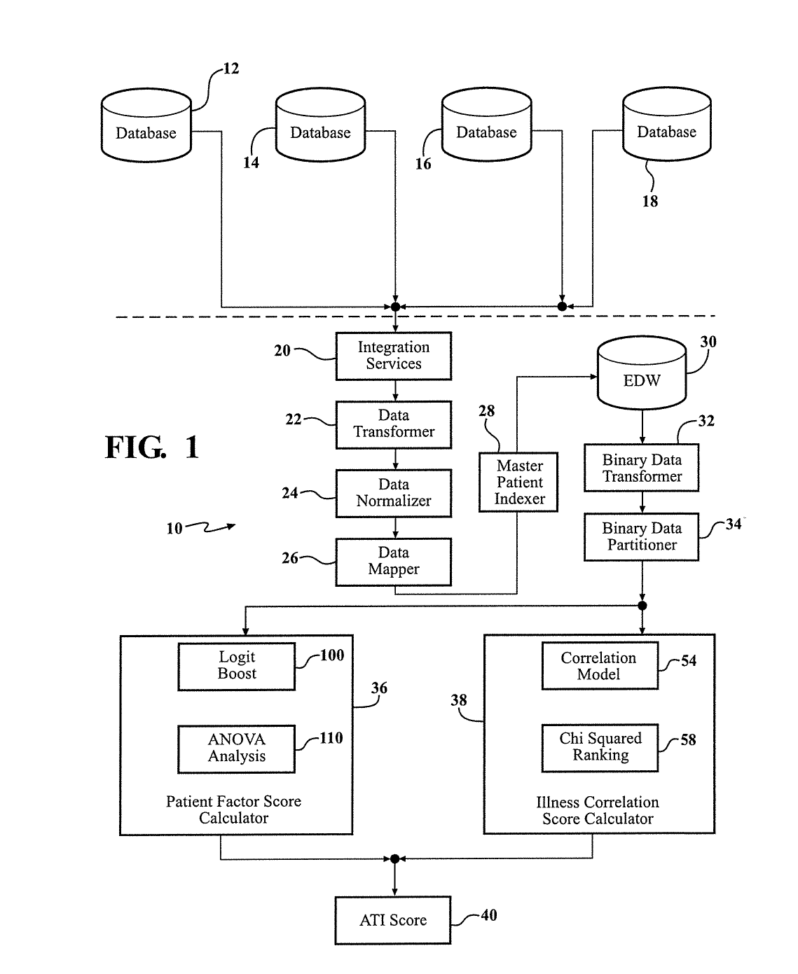

Referring to FIG. 1, one embodiment of the invention is generally indicated at 10. The invention 10 is a system for creating a score to identify how well a resource is going to impact on a patient or a patient population. This Ability to Impact (ATI) score is dependent upon receiving broad and discreet data from multiple disparate data sources, 12, 14, 16, 18. The disparate data source is 12, 14, 16, 18 are databases that have information that may be valuable in determining the ATI score. Disparate data sources 12, 14, 16, 18 represent third party data sources that may be used by the system 10 or third party applications that will receive the output of the system 10 for uses particular to those third party applications.

The inventive system 10 receives all of the data from the disparate data sources 12, 14, 16, 18 through an integration service 20. The integration service 20 brokers different protocols of data that are being received from the different disparate data sources 12, 14, 16, 18 so that the data may be transmitted through the inventive system 10 in a uniform fashion. The databases from which data is being received may be file based, IP based and the like and the integration services 20 collects the data regardless of the protocol from which it is being received. Once the data is integrated, it is transformed by a data transformer 22, it is normalized by a data normalizer 24 and it is mapped via a data mapper 26. It should be appreciated by those skilled in the art that any single processor could incorporate all of the steps of the integration services transformation, normalization and mapping into a single unit.

Discreet data is gathered from the disparate data sources 12, 14, 16, 18 include but are not limited to ambulatory systems, inpatient systems, health insurance exchanges, payers, care management systems, hospital systems, claims data, prescription data from pharmacies, pharmacy aggregators and pharmacy benefit managers, labs, patient biometric monitoring devices, credit score agencies, genomic databases and sources and search engines. The ability of the system 10 to support real-time, near real-time exchange of discreet and detailed data is a significant factor in providing accurate and timely population analytics and ATI scores. By way of example, the ATI score may include a factor for a “missed appointment,” whereby an ATI score of a patient is adjusted automatically upon learning that the patient missed an appointment.

The integrated services 20 provides the transport infrastructure and supports current and future standards based interfaces, such as HL7, CCD, CCR, XML, claims, and where applicable the IHE profiles used to integrate such as xdr, xds.b, etc. The integration services 20 also supports custom interfaces, capable of reaching directly into source systems to extract data.

The data that has been transformed, normalized and mapped is indexed by a master patient indexer (MPI) 28. The data is linked by the MPI 28, cleaned and mapped to a healthcare data model in an enterprise data warehouse (EDW) 30. The data that has been received from the disparate data sources, 12, 14, 16, 18 have been integrated, transformed, normalized, mapped and indexed to a particular patient or patient population before it is stored in the EDW 30. This facilitates the execution of analytics on the data set as a whole and provides a more complete and comprehensive view of patients and populations, as well as providers and payers.

Once the indexed data is stored in the EDW 30 it is transformed by a binary data transformer 32 into binary data. The binary data is then partitioned by a binary data partitioner 34.

The EDW 30 also stores historical cost data gathered from the disparate data sources 12, 14, 16, 18, such as payer claims and CMS. By statistically referencing, cross-referencing and analyzing the historical cost information for patients and populations against combinations of the discreet information gathered and organized in the EDW 30, the system 10 is able to identify the specific costs for each data element or factor, and each data element combination. Based on this information, the system 10 will create a patient ATI factor (discussed in greater detail subsequently) for each element. Again, by way of example, a data element would be representative of a condition like COPD or the ability to drive an automobile. Tables will store the actual costs for the patients and populations with the same combinations.

Once the binary data is partitioned, it is sent to a patient factor score calculator 36 and an illness correlation score calculator 38. The output of these two calculators 36, 38 create the ATI score 40. The calculators 36, 38 calculate the waiting, or specific value, for a specific risk factor, which is an ATI factor. Individual ATI factors are added together to create a persons ATI score. ATI scores for individual patients are added together to calculate and create a populations total ATI score. Data and specific factors such as claims, conditions, ICD 9, CPT 4, search engine results, credit scores, social status, diet, exercise, behavioural factors, medical information, active medications, medication compliance, allergies, social history, smoking history, missed scheduled office visits, socialization factors, ability to drive, alcohol consumption, family history, information from health risk assessments as well as other data elements that are gathered and organized in the EDW 30 are assigned an ATI factor. Again, when these ATI factors are added together, the patient and/or a population creates an ATI score. A user of the system 10 may calculate the expected impact upon projected spending and the ATI score of patients and populations by adding or deleting specific ATI factors. For example, if a patient has an ATI factor for blood sugar and is calculated at 0.5, a sample patients total ATI score is 4.5. The same patient responds to an aggressive campaign to reduce the blood sugar level, the result may be a reduced ATI score from 4.5 to 4.0.

By evaluating the spending histories associated with each individual in combination of risk elements for patients and populations with the same factors, the system 10 is able to assign an ATI score associated with the ATI factor for each risk component of that patient. By way of example, a component would include “does not have transportation” and “body mass index” and each could be assigned an ATI factor of 0.5. These ATI factors would be combined to create the patients total ATI score, which would be 1.0 in this case.

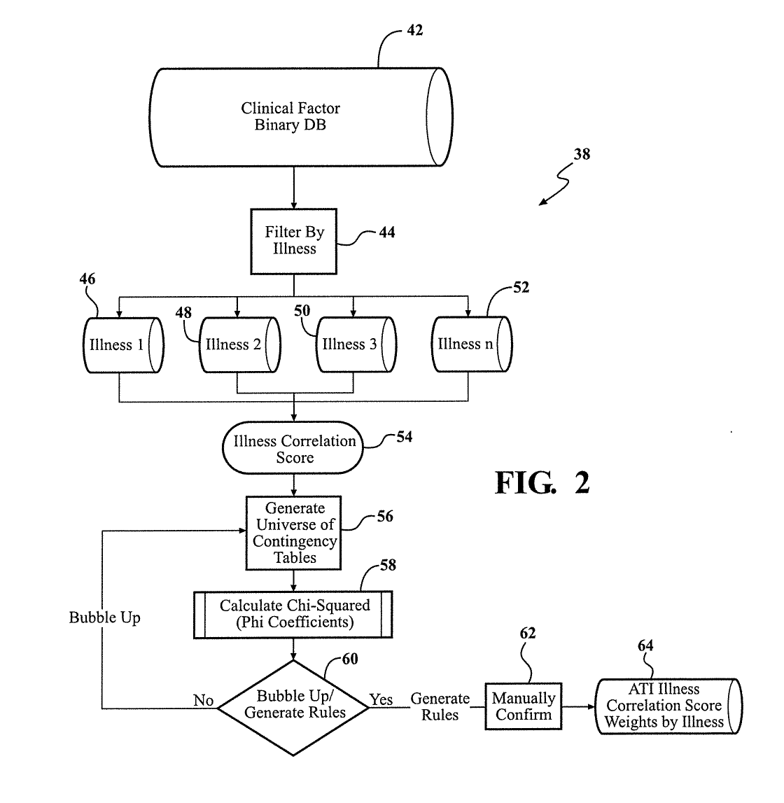

Referring to FIG. 2, the illness correlation score calculator 38 is generally shown in greater detail. The illness correlation score calculator 38 receives binary data from the binary data partitioner 34 through a clinical factor binary database 42. The data received is filtered by illness at 44. Graphically, there are four illnesses identified as illness 1, illness 2, illness 3 and illness n. These illnesses 46, 48, 50, 52 represent any number of illnesses that may be monitored by the system 10. Based on the data received as it is filtered through the illnesses 46, 48, 50, 52 an illness correlation score is generated at 54. The data is fed through a contingency tables database at 56. A Chi-Squared ranking occurs at 58. It is then determined at 60 whether the data complies with the rules being generated. If not, the system returns to the contingency tables at 56 to continue through the ranking method to ensure the highest valued factors from the illness correlations score calculator 38 are at the top of the table. Manual confirmation occurs at 62 and a database of ATI illness correlation scores are weighted by illness at 64.

The illness correlation score aims to categorize rules and weights specific to an illness. With the knowledge of what combinations of factors were seen in the highest cost patients, the system 10 can detect patterns and additionally create alerts to notify clients if new high risk combinations enter the database. The illness correlation score is calculated using a recursive Chi-Squared ranking algorithm. Initially, the binary clinical data is filtered specific to illness/affliction. The binary data is then transformed into 2×2 contingency tables 56, with a corresponding phi coefficient and Chi-Squared statistic. These Chi-Squared statistics are then ranked and combined amongst themselves. The two tier contingency tables with greater values are statistically more significant and when analyzed, are used to generate correlation rules for each illness. Subject matter experts then manually reject or accept the automated rule generation to arrive at a final set of correlations associated with the high cost patients for a specific illness.

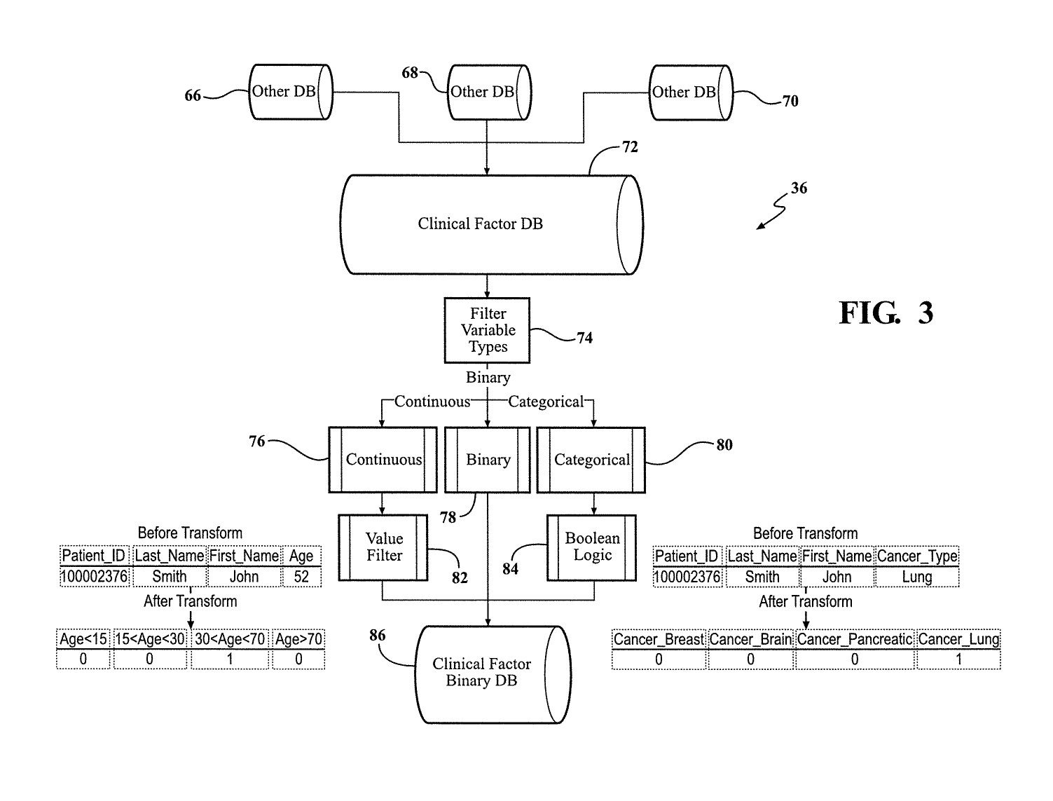

Referring to FIG. 3, a first portion of the patient factor score calculator 36 is generally shown. Data points and other information is received from various databases 66, 68, 70. These are all funnelled into a clinical factor database 72. Filters 74 filter the various types of data received. The patient factor score calculator 36 is designed to receive clinical data that is continuous, binary and categorical. The data is separated as such where it is treated by a continuous transform 76 a binary transform 78 and a categorical transform 80. With the continuous transform 76, the data is arranged by value using a value filter 82. A Boolean logic filter 84 is used to filter the categorical data 80. All of these data are combined into a clinical factor binary database 86.

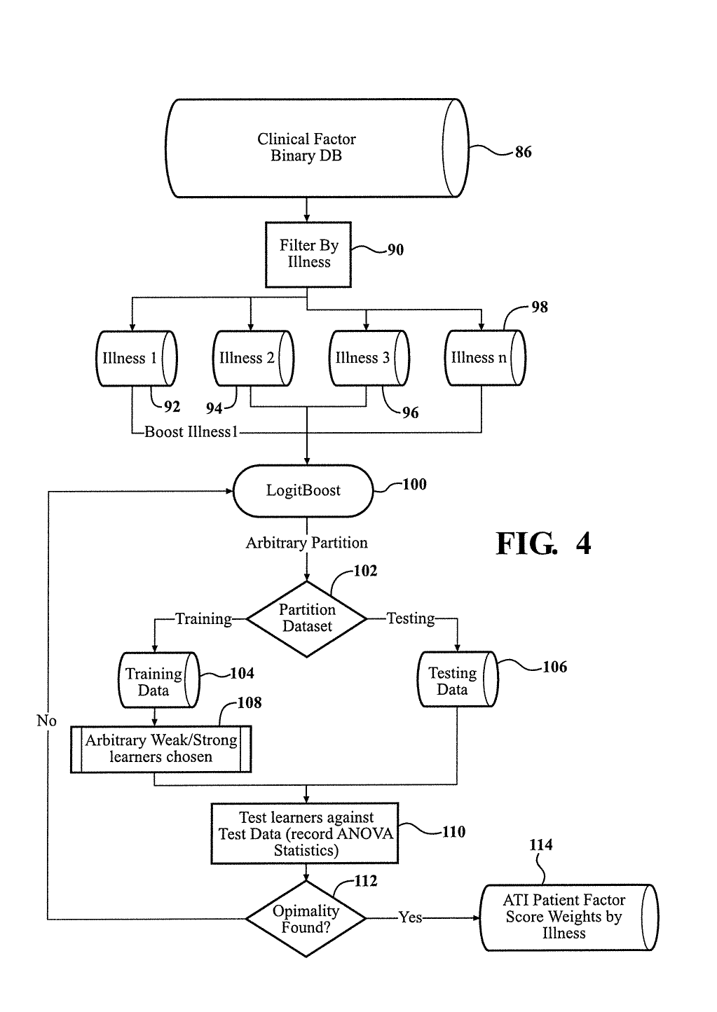

Referring to FIG. 4, the clinical factor binary database 86 is shown at the top thereof The data in the database is then filtered by illness at 90. As with FIG. 2, there are a number of illnesses graphically represented at 92, 94, 96, and 98. Once the data is filtered by illness, it is logistically regressed using LogitBoost 100. The LogitBoost 100 is configured specifically to generate clinical factor weighting unique to each illness and to each illness correlation score. The LogitBoost 100 uses exhaustive logistical regression (Logit) paired with predictive statistical boosting in order to assign weights and significance to each clinical factor. The LogitBoost 100 permeates the possibilities of weak/strong clinical factor learners and interactively generates a predicative rule based off these observances. This is recursively performed and re-calibrated, each iteration aiming to reduce the aggregate penalty error term. Once the data is logistically regressed, the data set is partitioned at 102 and to training data 104 and testing data 106. For training, arbitrarily weak and strong learners are chosen at 108. Once the regressions squared error has been minimally optimized using analysis of variance (ANOVA) 110. It is then tested to determine whether an optimal weighting has been found at 112. If not, the system loops back to the LogitBoost 100 and goes through another logistical regression and observation. If the optimal weighting is found, the ATI patient factor score weights by illness are stored at 114. The patient's patient ATI factor score is generated by applying their illness specific weights to their binary clinical data representation. The patient factor score maps the patients binary clinical data to a categorical threshold of risk. This threshold of risk represents a monetary value, thus the patient's perspective cost can be estimated given this system. Additionally, the patient factor score represents an illness specific score for the individual patient. This level of granularity allows the system 10 to further understand and act upon the driving factors for each illness as they relate to medical risk and cost.

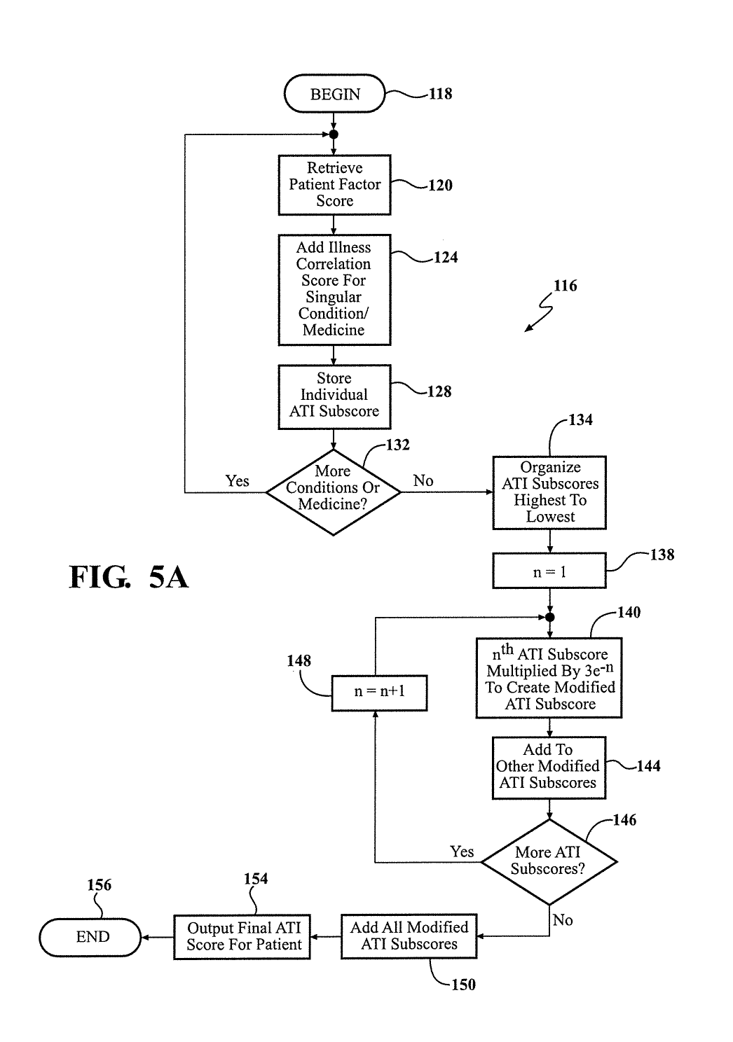

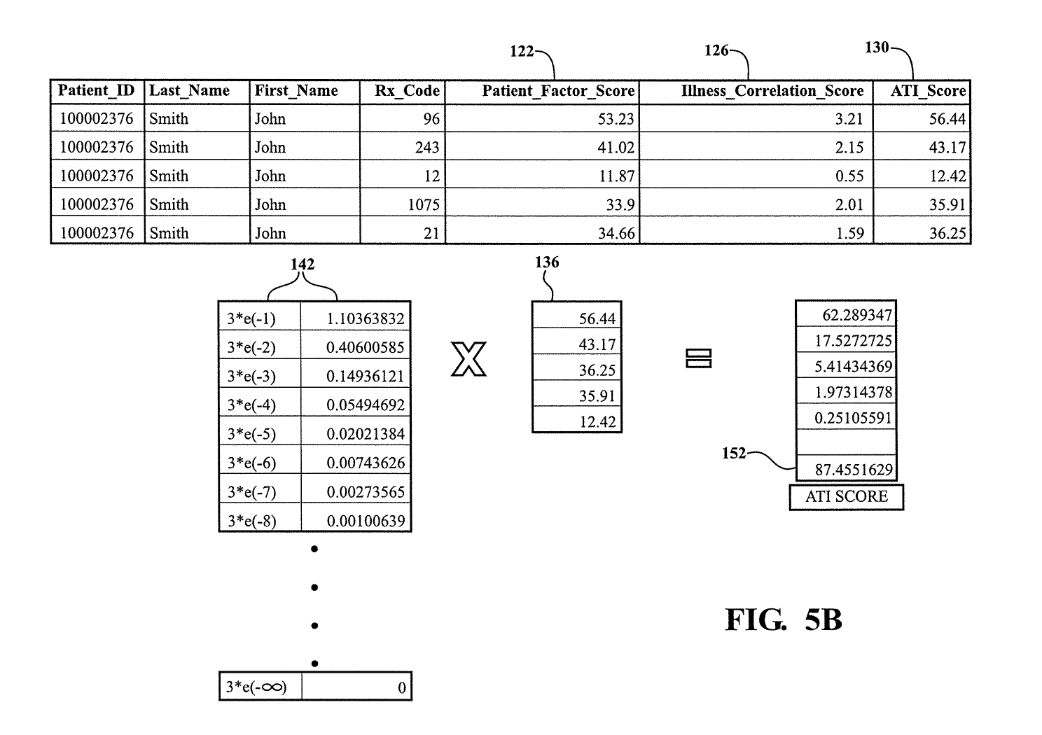

Referring to FIGS. 5A and 5B, a method for calculating an ATI score and the values used in an example calculation are shown, respectively. The method is generally shown at 116 in FIG. 5A. The method begins at 118. Patient factor scores are retrieved at 120. Patient factor scores are shown in a middle column 122 in FIG. 5B. An illness correlation score for singular conditions and/or medicine is added to the patient factor score at 124. An exemplary list of illness correlation scores is shown in column 126 in FIG. 5B. The individual ATI subscores are stored at 128. These ATI subscores are shown in column 130 in FIG. 5B. It is then determined whether there are more conditions or medicines to be factored at 132. If so, the method loops back and retrieves additional patient factor scores at 120. If not, the ATI subscores are organized from highest to lowest at 134. This is graphically represented by column 136 in FIG. 5B. A variable n is assigned a value of 1 at 138. The n^{th} ATI subscore is multiplied by 3e⁻ⁿ to create a modified ATI subscore at 140. This factor is shown in the two columns 142 of FIG. 5B. The modified ATI subscores are added together at 144. It is then determined whether more ATI subscores are to be calculated at 146. If so, a counter 148 increases the value of n and the next modified subscore is calculated at 140. If not all of the modified ATI subscores are added at 150. This is represented by cell 152 in FIG. 5B. The final ATI score for the patient is output at 154 and the method is terminated at 156. By way of example, the final ATI score for the patient in the example shown in FIG. 5B is 87.4551629.

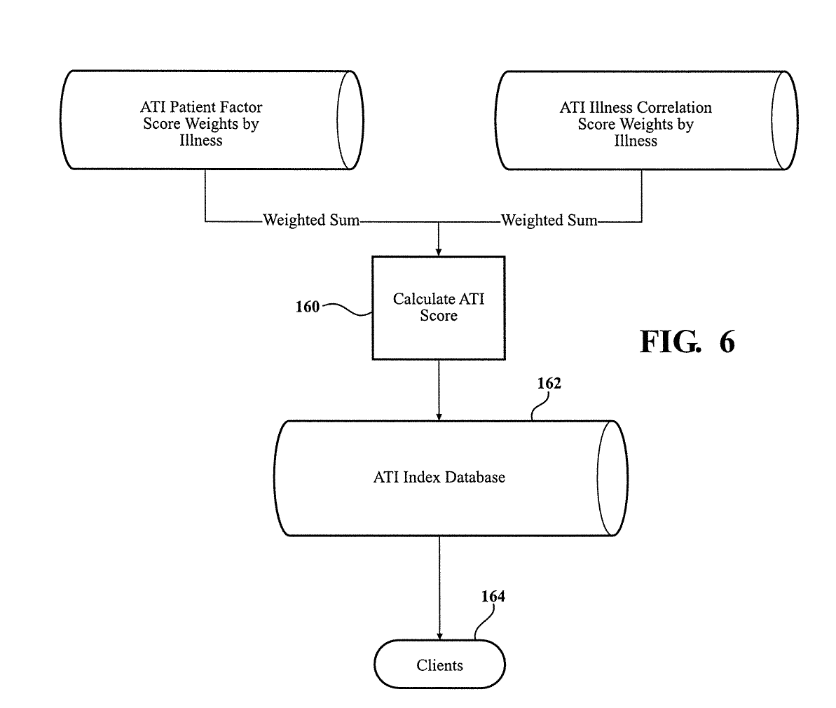

Referring to FIG. 6, it is shown that the ATI patient factor score weights by illness are combined with the ATI illness correlation score weights by illness and they are used to calculate an ATI score at 160. All of the ATI scores that are calculated are stored in an ATI index database at 162. This database is then accessible by clients 164 or published to clients 164 so that the entities involved with making decisions as to how resources are allocated to a particular population of patients or individual patients will be able to use the ATI index database to determine how best to use the resources available to maximize the benefit thereof.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. A method for maximizing usefulness of resources to be allocated to a class of patients, the method comprising the steps of:
receiving data on a patient;
partitioning the data;
calculating a patient factor score calculation;
calculating a patient illness correlation score calculation; and
generating an index for each patient to identify use of resources by which the resources will be applied to the patient to maximize the effectiveness of the resources.

2. A method as set forth in claim 1 wherein the step of receiving data includes the step of receiving data from a plurality of disparate sources.

3. A method as set forth in claim 2 including the step of normalizing the data received from the plurality of disparate sources.

4. A method as set forth in claim 3 including the step of transmitting the index back to the plurality of disparate sources.

5. A method as set forth in claim 1 wherein the step of calculating a patient factor score calculation includes the step of incorporating a logistic regression to maximize the accuracy of the patient factor score calculation.

6. A method as set forth in claim 5 wherein the step of incorporating the logistic regression includes the use of LogitBoost to optimize the patient factor score calculation.

7. A method as set forth in claim 1 wherein calculating the patient illness correlation score calculation includes the step of using a correlation model to operate on the data to create correlated data.

8. A method as set forth in claim 7 including the step of operating on the correlated data using a recursive Chi-Squared ranking system.

9. A method as set forth in claim 2 including the step of transforming the data from plurality of disparate sources into a transformed data set that can be utilized by the method.

10. A method as set forth in claim 9 including the step of normalizing the transformed data set to create a normalized data set.
